(19) United States
(12) Patent Application Publication
(10) Pub. No.: US 2006/0293063 A1
(43) Pub. Date: Dec. 28, 2006

(54) Peripheral resource location determination method, apparatus and system

(76) Inventor: Brad Corrion, Chandler, AZ (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/155,259

(22) Filed: Jun. 16, 2005

(51) Int. Cl. H04Q 7/20

(52) U.S. Cl. 455/456.1

(57) ABSTRACT

An embodiment of the present invention provides a method of peripheral resource location determination in a wireless environment, comprising determining an access point ID from an access point providing access to a wireless station (STA) in the wireless environment; querying a server on which resides a table of resources for each access point to determine peripherals within a predetermined distance from the STA; and reporting by the server to the STA the peripherals within said predetermined distance from the STA. The information for peripherals may be in map form, with the peripherals reported in relative position to the STA. The present method may further comprise utilizing multiple access points and triangulating a more exact position of the STA.

### BACKGROUND

Mobile communication, computing and wireless networks have become prevalent throughout society. Due to computing mobility and constantly changing wireless environments, it becomes difficult to ascertain available peripherals and their location. For example, if utilizing a public wireless network or traveling to an unfamiliar business site, and the need to use a printer, scanner or other peripheral associated with the network arises, it would be difficult to determine which peripherals are available, where they are and if they are online or not.

Thus, a strong need exists for peripheral resource location determination method, apparatus and system.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 illustrates the flow of one embodiment of the present invention detailing how an access point is used to identify a local peripheral resource.

It will be appreciated that for simplicity and clarity of illustration, elements illustrated in the figures have not necessarily been drawn to scale. For example, the dimensions of some of the elements are exaggerated relative to other elements for clarity. Further, where considered appropriate, reference numerals have been repeated among the figures to indicate corresponding or analogous elements.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

Some portions of the detailed description that follows are presented in terms of algorithms and symbolic representations of operations on data bits or binary digital signals within a computer memory. These algorithmic descriptions and representations may be the techniques used by those skilled in the data processing arts to convey the substance of their work to others skilled in the art.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Embodiments of the present invention may include apparatuses for performing the operations herein. An apparatus may be specially constructed for the desired purposes, or it may comprise a general purpose computing device selectively activated or reconfigured by a program stored in the device. Such a program may be stored on a storage medium, such as, but not limited to, any type of disk including floppy disks, optical disks, compact disc read only memories (CD-ROMs), magnetic-optical disks, read-only memories (ROMs), random access memories (RAMs), electrically programmable read-only memories (EPROMs), electrically erasable and programmable read only memories (EEPROMs), magnetic or optical cards, or any other type of media suitable for storing electronic instructions, and capable of being coupled to a system bus for a computing device.

The processes and displays presented herein are not inherently related to any particular computing device or other apparatus. Various general purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the invention as described herein. In addition, it should be understood that operations, capabilities, and features described herein may be implemented with any combination of hardware (discrete or integrated circuits) and software.

Use of the terms “coupled” and “connected”, along with their derivatives, may be used. It should be understood that these terms are not intended as synonyms for each other. Rather, in particular embodiments, “connected” may be used to indicate that two or more elements are in direct physical or electrical contact with each other. “Coupled” my be used to indicated that two or more elements are in either direct or indirect (with other intervening elements between them) physical or electrical contact with each other, and/or that the two or more elements co-operate or interact with each other (e.g. as in a cause and effect relationship).

It should be understood that embodiments of the present invention may be used in a variety of applications. Although the present invention is not limited in this respect, the devices disclosed herein may be used in many apparatuses such as in the transmitters and receivers of a radio system. Radio systems intended to be included within the scope of the present invention include, by way of example only, cellular radiotelephone communication systems, satellite communication systems, two-way radio communication systems, one-way pagers, two-way pagers, personal communication systems (PCS), personal digital assistants (PDA's), wireless local area networks (WLAN), personal area networks (PAN, and the like).

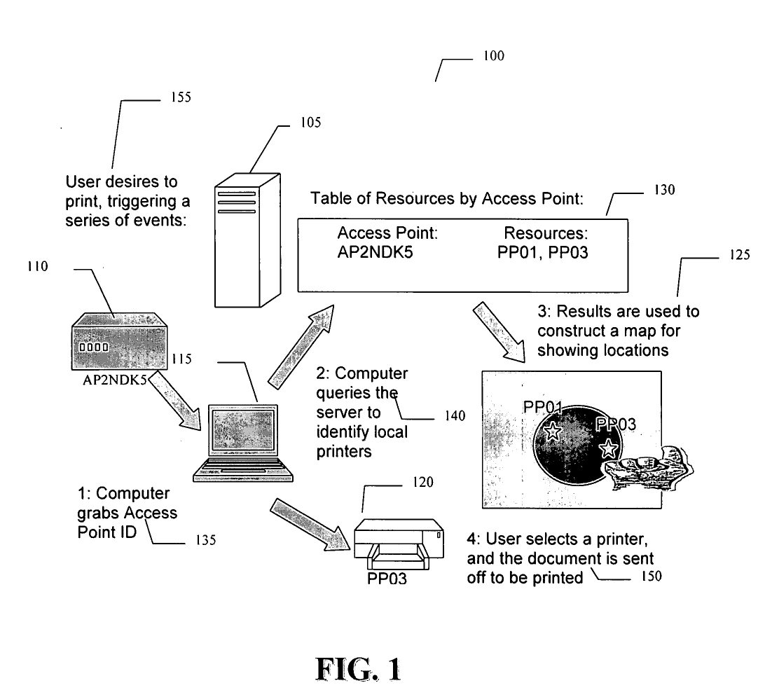

As illustrated in FIG. 1, generally as 100, an embodiment of the present invention provides a solution to the problem of locating peripheral resources 120 (such as, but not limit to, printers, scanners, multifunction devices) in computing environments by using information gathered from a computer's wireless networks, such as, but not limited to, the Institute for Electronic and Electrical Engineering (IEEE) 802.11a/b/g wireless networking connections, to identify geographically close resources. When wireless networking on a wireless device, such as computer 115 is enabled, the computer 115 may query a server 105 to correlate physical resources with the address of the wireless base station/access point (AP) 110. The result of the query is a list of resources, sorted by proximity to the base station and to the user. The relatively short distance of the wireless connection provides a reasonable exclusion of printing devices that a user may be confused by or simply is not willing to sort through. A map 125 may then be drawn showing local geography, the location of the access point 110, and the location of the printing resources 120. Triangulation of multiple base stations could more precisely detect the location of the user in order to provide a list of appropriate devices.

For illustrative purposes only and not limited by these usages, two typical usage situations are as follows. One situation may be when the user is a stranger in a new environment without knowledge of the networking infrastructure. In this case the user does not have to browse random network topology trees, does not have to wander aimlessly around an environment hoping to find a shareable resource, and does not have to ask other persons as to the whereabouts of a printer. Examples: Starbucks, Kinkos, Libraries).

Another example situation is a typical corporate environment where the user may be near multiple printers, yet the corporation maintains hundreds, if not thousands, of printers. The user typically wanders around looking for public print stations, scribbles the printer's SMB network name on scrap paper, and returns to their computer in order to connect to the printer and print their document. They do this because searching for a printer in the list of managed printers is fruitless. An embodiment of the present invention improves on this scenario by providing the subset of printers that are geographically nearby, allowing the user to quickly select one and print to the device.

An embodiment of the present invention also provides a method of peripheral resource location determination in a wireless environment after a user desires to locate 155 a peripheral 120, comprising determining an access point ID 135 from an access point 110 providing access to a wireless station (STA) such as computer 115 in said wireless environment; querying 140 a server 105 on which resides a table of resources 130 for each access point 135 to determine peripherals 120 within a predetermined distance from the STA 115; and reporting by the server 105 to the STA 115 the peripherals 120 within the predetermined distance from the STA 115. A user may then select which peripheral to utilize 150.

Also provided in an embodiment of the present invention is a peripheral location system, comprising an access point 110 with an access point ID 135; a wireless station 115 capable of wireless communication with the access point 110 and acquiring the access point ID 135; a server 105 capable of communication with the wireless station 115, the server 105 including a table of resources 130 for each access point 110 to determine peripherals 120 within a predetermined distance from the STA 110. The table of resources 130 may correlate access point IDs with available peripherals 120 near the access point 110.

In another embodiment of the present invention is provided an article comprising a machine-accessible medium having one or more associated instructions, which if executed, results in peripheral resource location determination in a wireless environment by determining an access point ID from an access point providing access to a wireless station (STA) in the wireless environment, querying a server on which resides a table of resources for each access point to determine peripherals within a predetermined distance from the STA; and reporting by the server to the STA the peripherals within the predetermined distance from the STA.

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

1. A method of peripheral resource location determination in a wireless environment, comprising:
determining an access point ID from an access point providing access to a wireless station (STA) in said wireless environment;
querying a server on which resides a table of resources for each access point to determine peripherals within a predetermined distance from said STA; and
reporting by said server to said STA the peripherals within said predetermined distance from said STA.

2. The method of claim 1, further comprising reporting the position of said peripherals in map form, with said peripherals reported in relative position to said STA.

3. The method of claim 1, further comprising providing the capability to activate said peripheral by interaction with said map.

4. The method of claim 1, wherein said peripheral is a printer.

5. The method of claim 1, further comprising communicating with multiple access points and triangulating a more exact position of said STA to provide more precise peripheral location relative to said STA.

6. The method of claim 1, wherein said STA is a mobile computer.

7. The method of claim 1, further comprising including in said report by said server additional criteria to discriminate peripherals reported by said server.

8. An apparatus, comprising:
a wireless station (STA) capable of peripheral resource location determination in a wireless environment by determining an access point ID from an access point in communication with said STA and querying a server on which resides a table of resources for each access point to determine peripherals within a predetermined distance from said STA.

9. The apparatus of claim 8, wherein said STA further comprises a screen to report said peripheral location in map form.

10. The apparatus of claim 8, wherein said peripheral is a printer.

11. The apparatus of claim 8, wherein said STA is capable of communicating with multiple access points and triangulating a more exact position of said STA to provide more precise peripheral location relative to said STA.

12. The apparatus of claim 8, wherein said STA is a mobile computer.

13. The apparatus of claim 8, further comprising including in said report by said server additional criteria to discriminate peripherals reported by said server.

14. A peripheral location system, comprising:
an access point with an access point ID;
a wireless station capable of wireless communication with said access point and acquiring said access point ID;
a server capable of communication with said wireless station, said server including a table of resources for each access point to determine peripherals within a predetermined distance from said STA.

15. The peripheral location system of claim 14, wherein said table of resources correlates access point IDs with available peripherals near said access point.

16. The peripheral location system of claim 14, wherein said wireless station is a mobile computer.

17. An article comprising a machine-accessible medium having one or more associated instructions, which if executed, results in peripheral resource location determination in a wireless environment by determining an access point ID from an access point providing access to a wireless station (STA) in said wireless environment, querying a server on which resides a table of resources for each access point to determine peripherals within a predetermined distance from said STA; and reporting by said server to said STA the peripherals within said predetermined distance from said STA.

18. The article of claim 17, further comprising reporting the position of said peripherals in map form, with said peripherals reported in relative position to said STA.

19. The article of claim 17, further comprising providing the capability to activate said peripheral by interaction with said map.

20. The method of claim 1, wherein said peripheral is a printer.
